(19) United States
(12) Patent Application Publication
(10) Pub. No.: US 2015/0277699 A1
(43) Pub. Date: Oct. 1, 2015

(54) INTERACTION METHOD FOR OPTICAL HEAD-MOUNTED DISPLAY

(71) Applicant: Cherif Atia Algreatly, Newark, CA (US)

(72) Inventor: Cherif Atia Algreatly, Newark, CA (US)

(73) Assignee: Cherif Atia Algreatly, Newark, CA (US)

(21) Appl. No.: 14/242,814

(22) Filed: Apr. 1, 2014

(51) Int. Cl. G06F 3/0481; G06F 3/0488; G06F 3/0484; G06F 3/01

(52) U.S. Cl. CPC G06F 3/04815; G06F 3/017; G06F 3/04883; G06F 3/04842

(57) ABSTRACT

A method of interaction with virtual data is disclosed. The method allows the user to select virtual data from a device display and relocate this virtual data to be stationed at a location in the air, regardless of the movement of the user. The user can move, rotate or resize the virtual window in the air. The content of the virtual window can be associated with online content such as a URL selected by the user. A group of users located in the same location or different locations, can interact with virtual data suspended in the atmosphere around them. Each one of the users can select virtual data on a device display and drag the virtual data to a desired position in mid-air. All users can view the virtual data at its new location by aiming a device display towards this location. The device can be OHMD, HMD, tablet, or mobile phone, as well as, a retinal projector.

### CROSS-REFERENCE TO RELATED APPLICATION

This application claims the benefits of a U.S. Provisional Patent Application No. 61/835,351, filed Apr. 2, 2013, titled “Method For Positioning and Displaying Digital Data”.

### BACKGROUND

The head-mounted display, abbreviated HMD, is a head worn display device working as an extension of a computer in the form of eye glasses or helmet; it has a small display positioned in front of a user's eyes. The optical head-mounted display (OHMD), such as GOGGLE GLASS, is a wearable display that has the capability of reflecting projected images and also allows the user to see through it. The major applications of HMD and OHMD include military, governmental (fire, police, etc.) and civilian/commercial (medicine, video gaming, sports, etc.) use.

For example, in the aviation field, HMDs are increasingly being integrated into the modem pilot's flight helmet. In the rescue field, firefighters use HMDs to display tactical information, like maps or thermal imaging data, while simultaneously viewing a real scene. In the engineering field, engineers use HMDs to provide stereoscopic views of drawings by combining computer graphics, such as system diagrams and imagery, with the technician's natural vision. In the medical field, physicians use HMDs during surgeries, where a combination of radiographic data (CAT scans and MRI imaging) is combined with the surgeon's natural view of the operation, and the anesthesiologist can maintain knowledge of the patient's vital signs through data presented on the HMDs.

In the gaming and entertainment fields, some HMDs have a positional sensing system which permits the user to view their surroundings, with the perspective shifting as the head is moved, thus providing a deep sense of immersion. In sports, a HMD system has been developed for car racers to easily see critical race data while maintaining focus on the track. In the skill training field, a simulation presented on the HMD allows the trainer to virtually place a trainee in a situation that is either too expensive or too dangerous to replicate in real-life. Training with HMDs covers a wide range of applications such as driving, welding and spray painting, flight and vehicle simulators, dismounted soldier training, medical procedure training and more.

Recent OHMDs were developed to serve all aforementioned fields. For example, GOOGLE GLASS, which is a wearable computer with an optical head-mounted display, has been developed by GOOGLE. It displays information in a smartphone-like hands-free format that can communicate with the Internet via natural language voice commands. Many other companies have developed OHMDs similar to GOOGLE GLASS with less or more features or differing capabilities.

Generally, the two main disadvantages of using the HMDs and OHMDs are their limited visual area on which to display digital data, and the difficulty the user experiences interacting with digital data presented in front of his/her eyes. The area assigned for displaying the digital data on the HMD or OHMD is miniscule in comparison to the larger screens of computers and tablets. Also, the interaction with the digital data on the HMDs or OHMDs cannot employ a traditional computer input device, such as a computer mouse or computer keyboard, when the user is standing, walking, or lying supine. If there is a solution for the two aforementioned problems, the use of the HMDs and OHMDs will dramatically be improved to aptly serve military, government and civilian/commercial interests.

### SUMMARY

The present invention discloses a method for interaction with the digital data presented on a display. The display can be a HMD, OHMD, a tablet screen, mobile phone screen, or the like. The method resolves the aforementioned two problems. Accordingly, the digital data presented on the display becomes unrestricted to the dimensions or size of the display, and the user can easily interact with digital data without using a computer input device while s/he is standing, walking, or lying supine. Thus, the present invention enhances the various applications and uses of the HMDs and OHMDs, and creates new applications for tablets and mobile phones.

In one embodiment, the present invention enables a user to select virtual data on a display and position the virtual data in mid-air around the user. The virtual data remains stationed at its new location, regardless of the movements the user makes. The user can view the virtual data at its new location once the display is faced towards this new location. The user can also select and relocate the virtual data from its new location in the air to the display. In another embodiment, the present invention enables a user to select virtual data on a display and relocate to attach this virtual data to a real object, such as a wall or piece of furniture located in the surrounding environment of the user. The virtual data remains attached to the real object regardless of the movement of the user. The user can view the virtual data attached to the real object once the display is aimed towards the real object.

The selection of the virtual data can be achieved in various manners, such as using gesture recognition, voice commands, picture capturing, or the like. The relocation of the virtual data can be achieved in various ways, such as hand movements, device movement, or providing numerical data representing the position of the new location of the virtual data. Accordingly, the present invention turns the surrounding environment of the user into a large virtual display that can hold much more digital data than the size of the display, whether this display is a tablet, mobile phone, HMD, or OHMD. The virtual data may contain digital text, images, or videos. The text, images, or videos can be associated with a URL of online content such, as a website. Accordingly, the virtual data simultaneously changes with the change of the online content. The user can view this online content once the display is aimed towards the position of the virtual data.

In another embodiment, the present invention enables a group of users to interact with virtual data located suspended in the atmosphere around them. Each one of the users can select virtual data on a device display and drag the virtual data to a desired position in mid-air. All users can view the virtual data at its new location by aiming a device display towards this location. This innovative application enhances the collaborative interaction of a group of users with virtual data, opening the door for various gaming, entertainment, educational, and professional computer applications.

Generally, the above Summary is provided to introduce a selection of concepts in a simplified form that is further described below in the Detailed Description. This Summary is not intended to identify key or essential features of the claimed subject matter, nor is it intended to be used as an aid in determining the scope of the claimed subject matter.

### BRIEF DESCRIPTION OF DRAWINGS

FIG. 1 illustrates an example of digital data presented in three virtual windows on an OHMD.

FIG. 2 illustrates a user's finger pointing to a virtual window as an indication for selecting this window.

FIG. 3 illustrates moving the finger after selecting the virtual window on the display to simultaneously move the virtual window with the finger movement in mid-air.

FIG. 4 illustrates the disappearance of the virtual window on display when the OHMD is not facing the position of the virtual window.

FIG. 5 illustrates the appearance of the virtual window on the display when the OHMD is facing the position of the virtual window.

FIG. 6 illustrates rotating the virtual window horizontally, in mid-air, relative to the OHMD.

FIG. 7 illustrates moving the virtual window, in mid-air, away from the OHMD or the user's point of view.

FIG. 8 illustrates moving the virtual window, in mid-air, closer to the OHMD or the user's point of view.

FIG. 9 illustrates a plurality of virtual windows positioned in mid-air, inside a room, after dragging them from a display.

FIG. 10 illustrates moving, rotating, and resizing the plurality of the virtual windows to change their configuration.

FIG. 11 illustrates seven virtual windows positioned in two groups relative to a user's point of view.

FIG. 12 illustrates moving and rotating the seven virtual windows to display them in one group relative to a user's point of view.

FIG. 13 illustrates moving, rotating, and resizing the seven virtual windows to display them in a different configuration relative to a user's point of view.

FIG. 14 illustrates a user's finger selecting a virtual window on a mobile phone screen to position the virtual window in a new location in the air.

FIG. 15 illustrates moving the virtual window from the mobile phone screen with a finger movement in mid-air.

FIG. 16 illustrates a finger pointing to a virtual window presented on a computer display while a camera is tracking the finger direction.

FIG. 17 illustrates changing the direction of the finger, after selecting the virtual window, to relocate the virtual window in a new position along the finger's new direction.

FIG. 18 illustrates a user's hand holding a computer input device in the form of a stylus to remotely select a 3D object presented on a tablet display.

FIG. 19 illustrates moving the 3D object with the movement of the computer input device so it is located in a new position outside the tablet display.

FIG. 20 illustrates an OHMD in the form of eye glasses where a finger is touching the frame of the eye glasses to select and relocate a virtual object presented on the OHMD.

FIG. 21 illustrates a virtual window presented on an OHMD where a real table located in front of the user appears beside the virtual window.

FIG. 22 illustrates moving the virtual object to attach it to the table surface, according to one embodiment of the present invention.

FIG. 23 illustrates three virtual windows presented on an OHMD where real walls located in front of the OHMD appear behind the three virtual windows.

FIG. 24 illustrates relocating the three virtual windows so they are attached to the real walls, according to one embodiment of the present invention.

FIG. 25 illustrates a virtual 3D object presented on an OHMD where a real table located in front of the OHMD appears beside the virtual 3D object.

FIG. 26 illustrates positioning the virtual 3D object on the table surface, according to one embodiment of the present invention.

FIGS. 27 and 28 illustrate viewing the virtual 3D object from different points of view when the user moves around the table with the OHMD.

FIG. 29 illustrates moving a virtual window from a mobile phone screen to a position in mid-air, according to one embodiment of the present invention.

### DETAILED DESCRIPTION

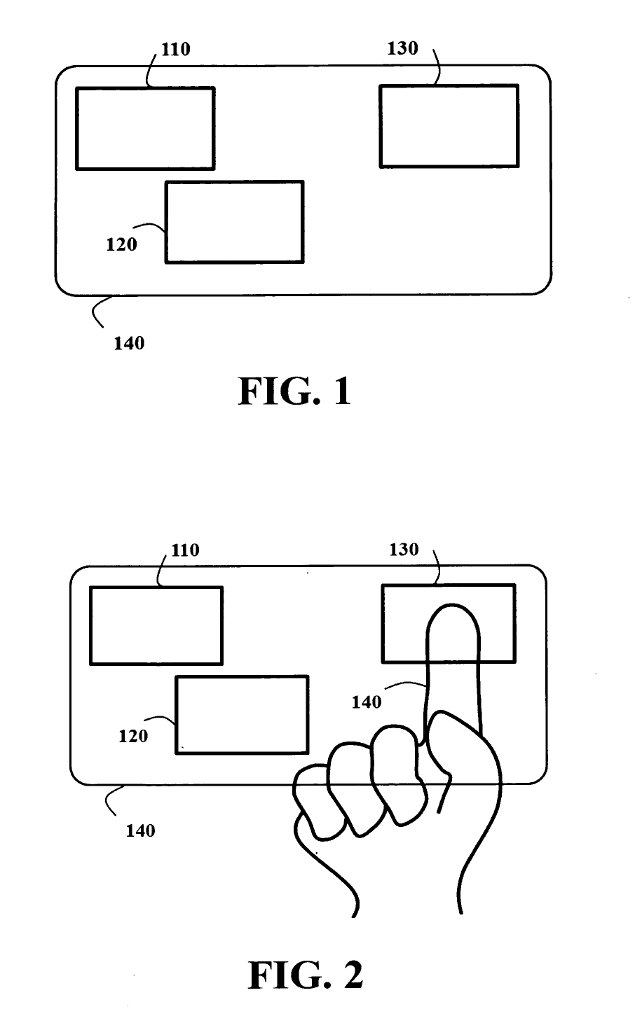

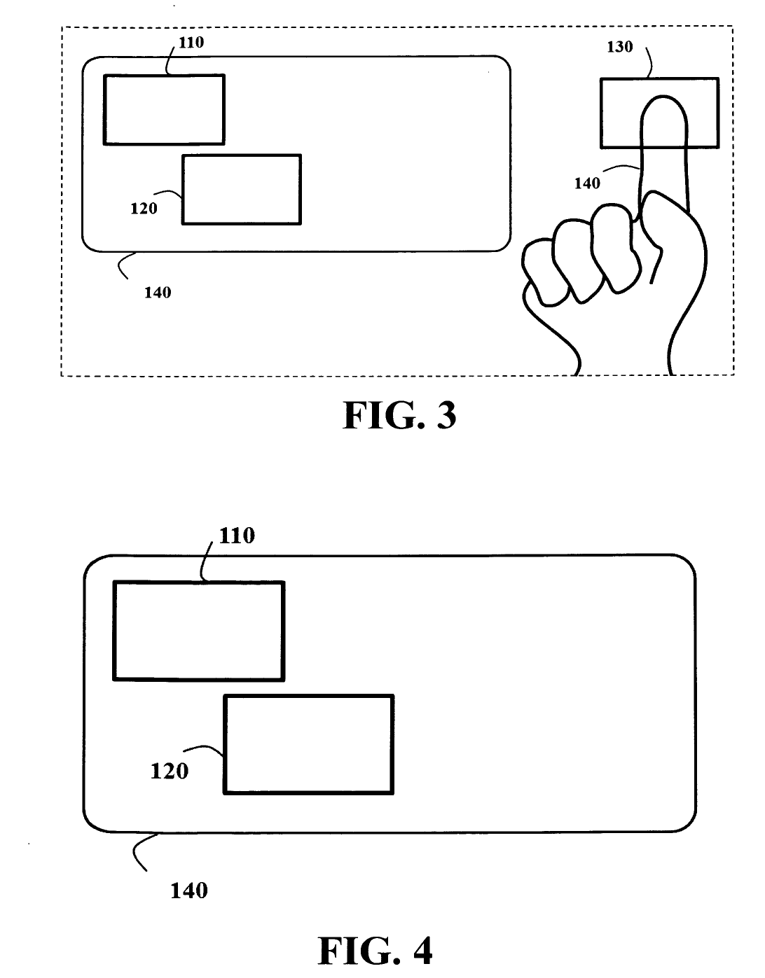

FIG. 1 illustrates an example of virtual data presented in a first window 110, second window 120, and third window 130 on an OHMD such as GOOGLE GLASS. The virtual data in each window contains text, image, video, or the like. FIG. 2 illustrates a user's finger 140 pointing to the third window as an indication for selecting this window. Once the user selects a window on the OHMD, the window attaches to the finger. In other words, the selected window is moved through the user's environment with finger movement. For example, FIG. 3 illustrates moving the finger away from the OHMD and the window keeps moving with the finger movement outside the OHMD. The finger movement is tracked by a camera connected to the OHMD. Although the third window does not appear on the OHMD, its location relative to the OHMD or the user's eyes is determined.

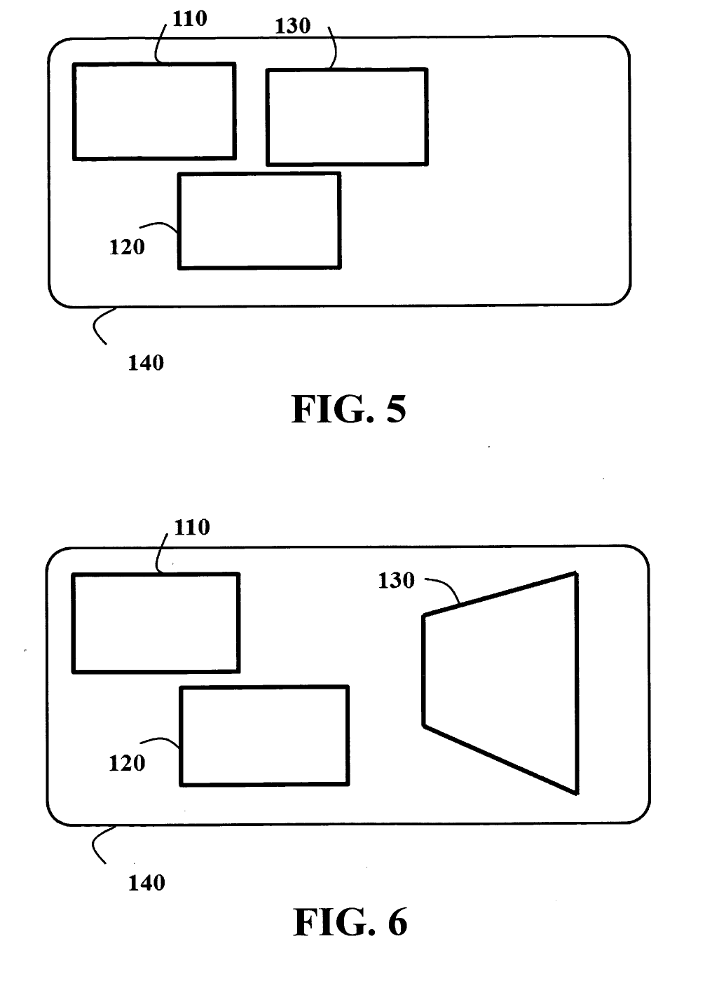

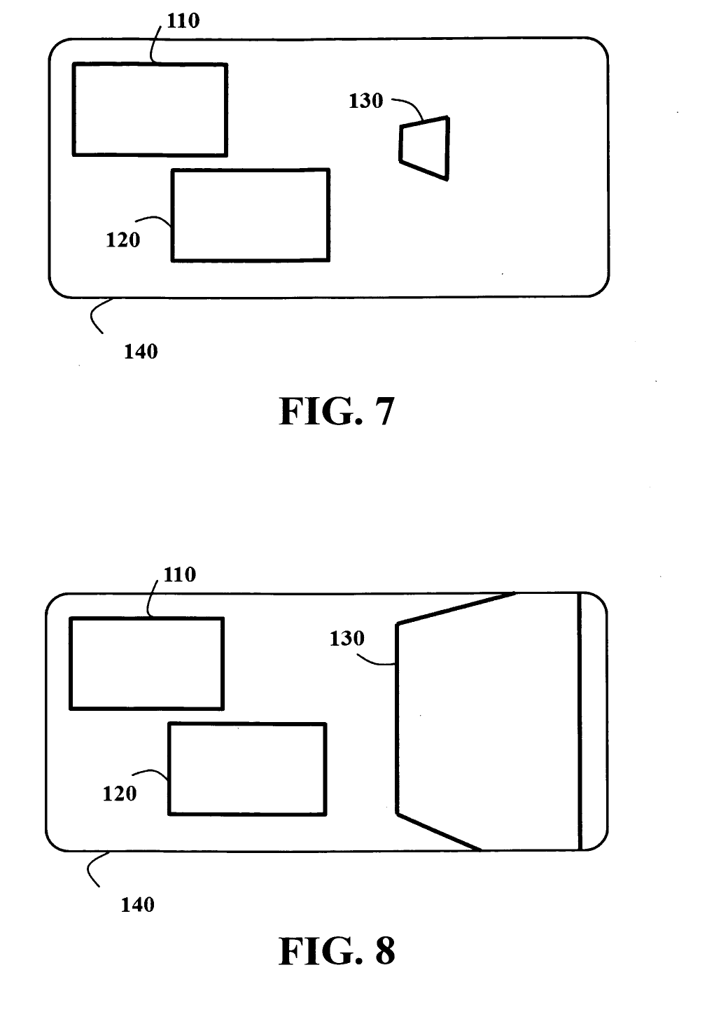

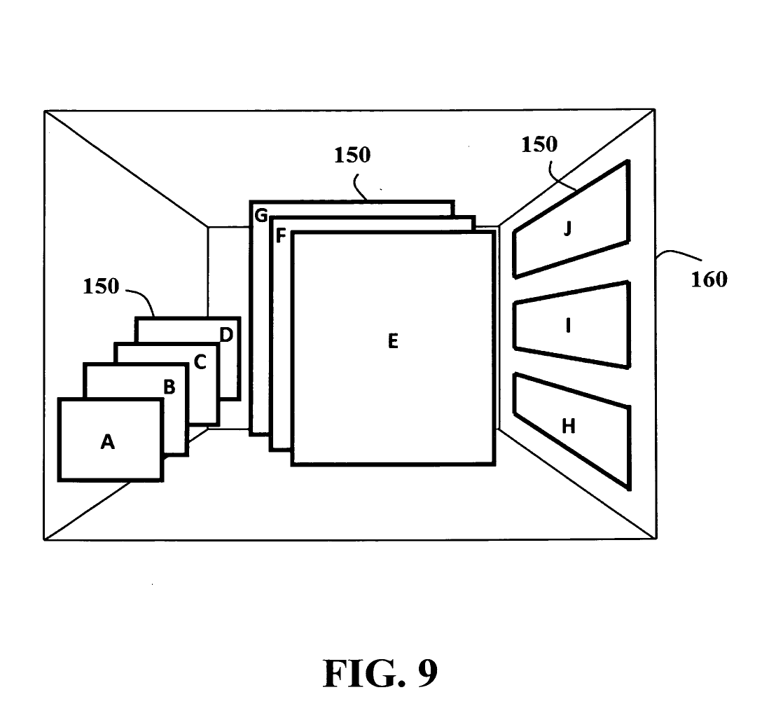

FIG. 4 illustrates the disappearance of the third window on the OHMD when the user is looking away from the location of the third window. FIG. 5 illustrates the appearance of the third window 130 on the OHMD when the user rotates his/her head with the OHMD towards the location of the third window. Generally, once a window is selected the user can rotate the window vertically or horizontally relative to the OHMD, move the window away or closer to the OHMD, or increase or decrease the size of the window. For example, FIG. 6 illustrates rotating the third window 130 horizontally relative to the OHMD. FIG. 7 illustrates moving the third window away from the OHMD to look smaller. FIG. 8 illustrates moving the third window closer to the HOMD to look bigger. As shown in the last figure, the third window is partially presented on the OHMD, where the user needs to move away from the location of the third window to entirely view it, or to resize the third window by making it smaller.

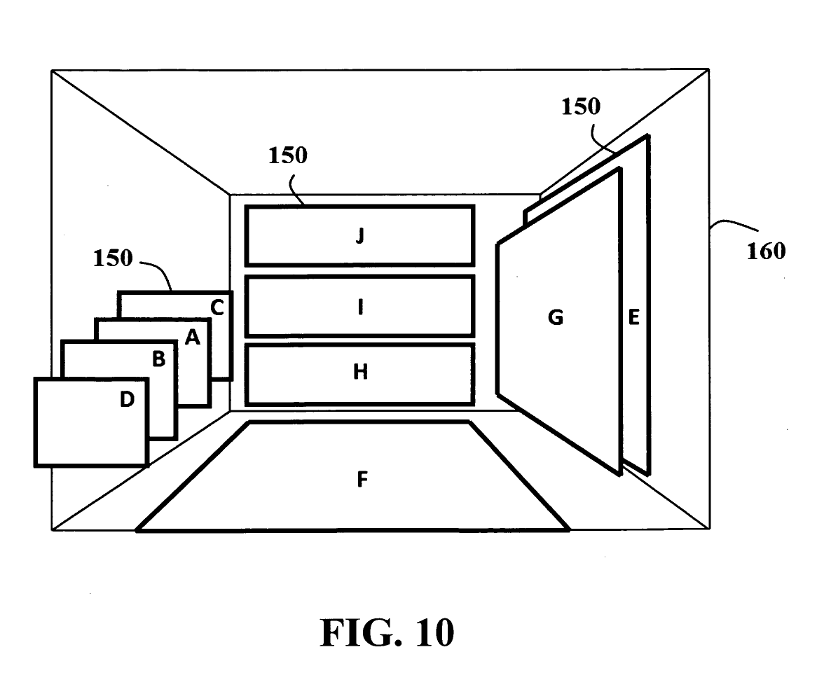

Using the present invention to select windows on the OHMD and navigate these windows through the user's environment opens the door for a variety of innovative computer applications. For example, FIG. 9 illustrates a plurality of windows 150 positioned in the air inside a room 160 after selecting and moving them relative to an OHMD. Since the location of each window is determined relative to the OHMD position, the user can move in the room to view the windows from different points of view. This is achieved by tracking each new position of the OHMD and determining the location of the each window relative to the new position of the OHMD, as will be described subsequently. As shown in the previous figure, each window is tagged with an English letter starting with “A” and ending with “J”. In FIG. 10 the user relocated the windows inside the room by rotating some windows horizontally or vertically, and moving some windows relative to the position of the OHMD, as was described previously.

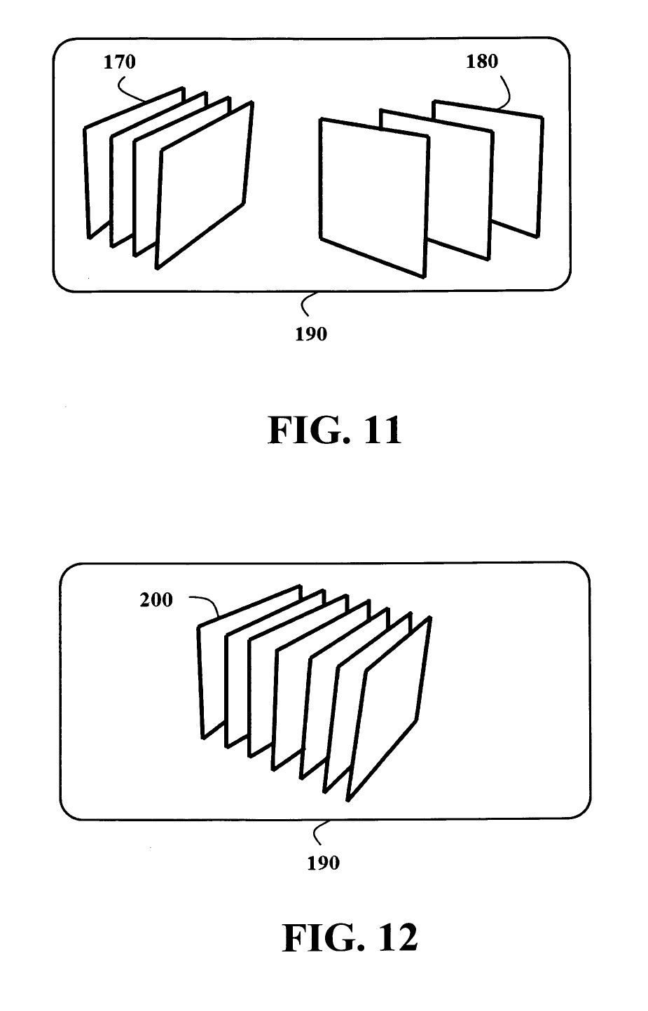

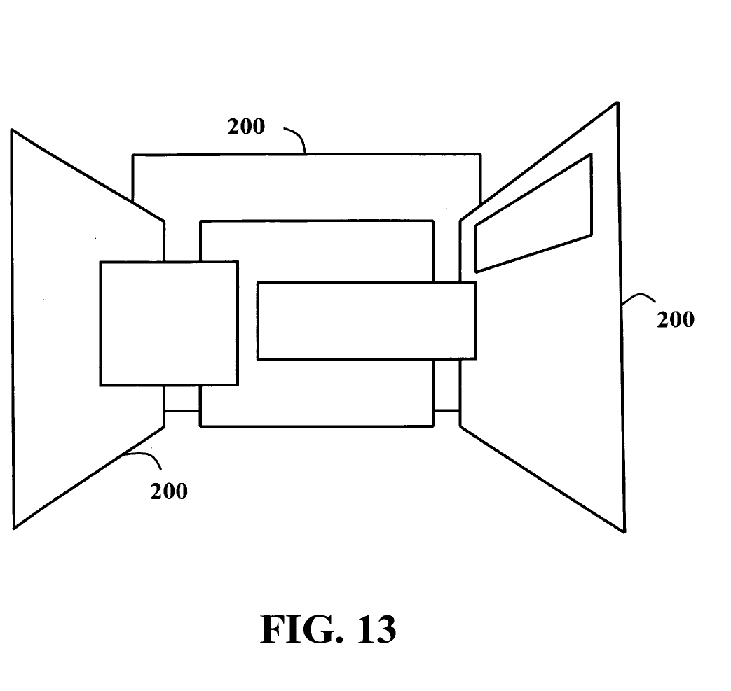

FIG. 11 illustrates seven windows positioned in a first group 170 and a second group 180 relative to an OHMD 190 worn by a user. FIG. 12 illustrates rotating and relocating the seven windows to form a single group of windows 200. FIG. 13 illustrates moving, rotating, and resizing the seven windows 200 relative to the OHMD to form the shown configuration. In this case, the user can walk through the seven windows to view them from different points of view. Once the user walks to face a window, the user can interact with any digital data presented in this window. The interaction with the digital data displayed on the window may include typing, editing, dragging the digital data within the confines of the window, or dragging the digital data in the air outside the windows, as was described previously.

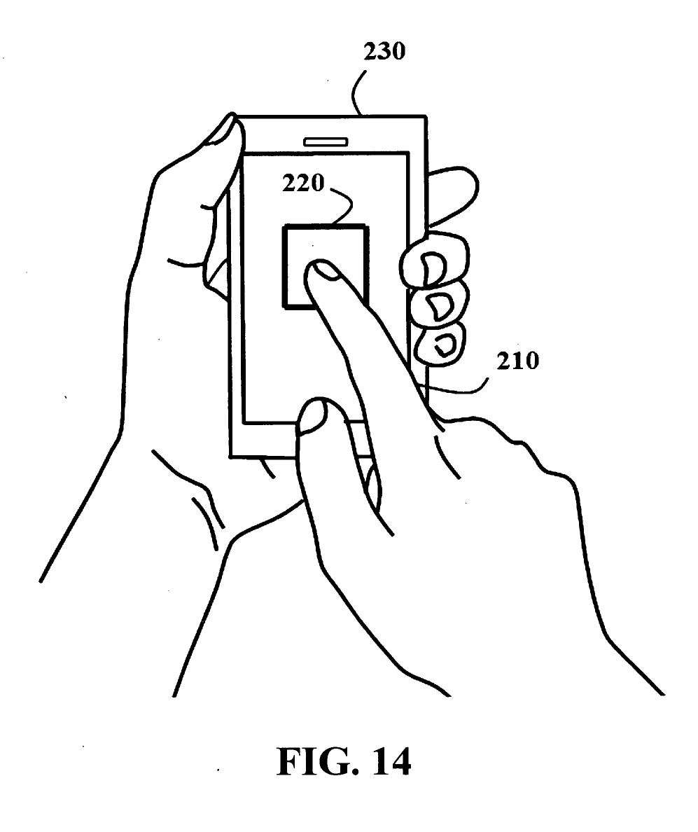

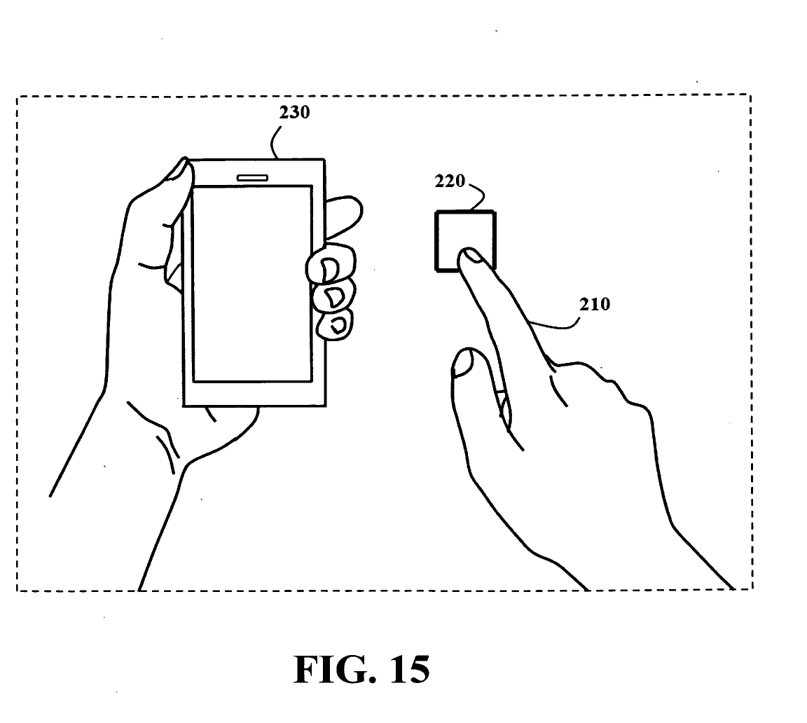

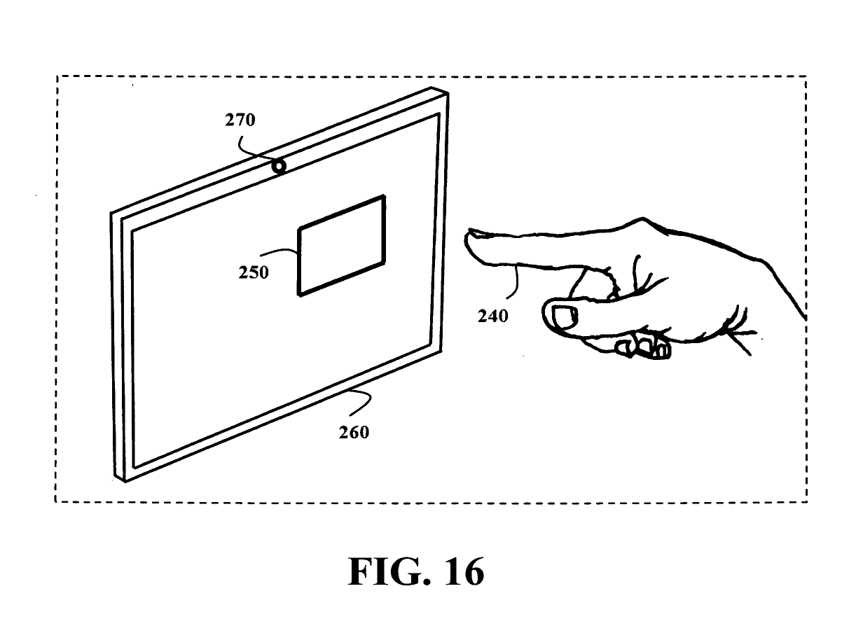

Generally, the method of the present invention can be utilized with OHMDs, HMDs, tablets, mobile phones, and computers. For example, FIG. 14 illustrates a user's finger 210 selecting a window 220 on a mobile phone screen 230, while FIG. 15 illustrates moving the window with finger movements to position the windows outside the dimensions of the mobile phone screen. In this case, the new location of the window can be seen through the mobile phone screen when moving the camera of the mobile phone towards this new location. If the user is wearing an OHMD such as GOOGLE GLASS, in this case too, the window can be seen at its new location through the OHMD once the user rotates his/her head towards the window location.

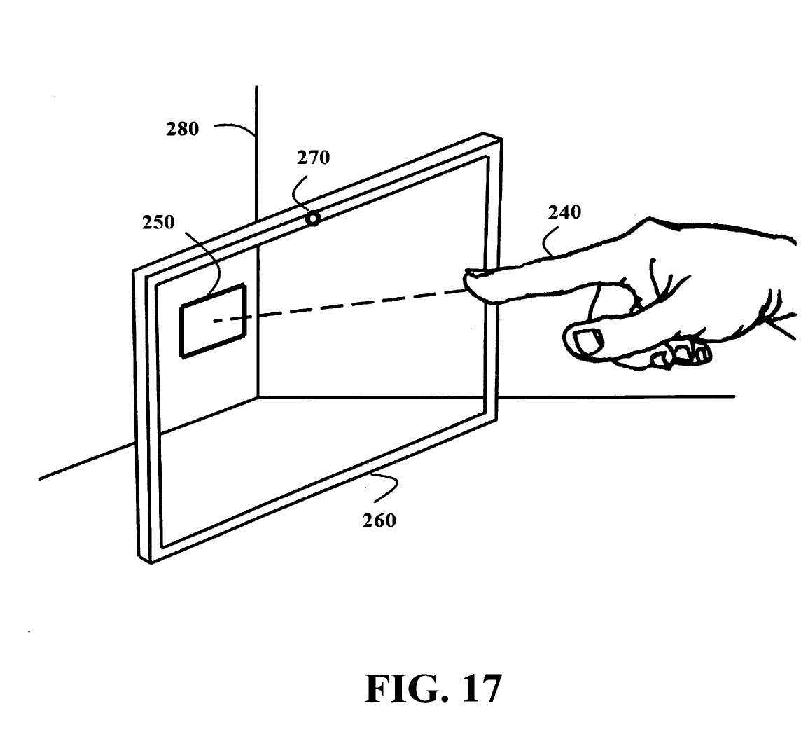

FIG. 16 illustrates a finger 240 pointing to a window 250 presented on a computer display 260 where a camera 270 tracks the finger direction to determine which window the finger is selecting. Once the window is selected, it moves with the finger movement which can also be tracked by the camera. Accordingly, the window can be virtually relocated in a position other than its original position. For example, FIG. 17 illustrates changing the direction of a finger to relocate the window in another position behind the computer display. In this case, another camera is utilized in the back of the computer display to capture the scene behind the computer display 280 and present the window with the scene as an augmented reality application, as shown in the figure.

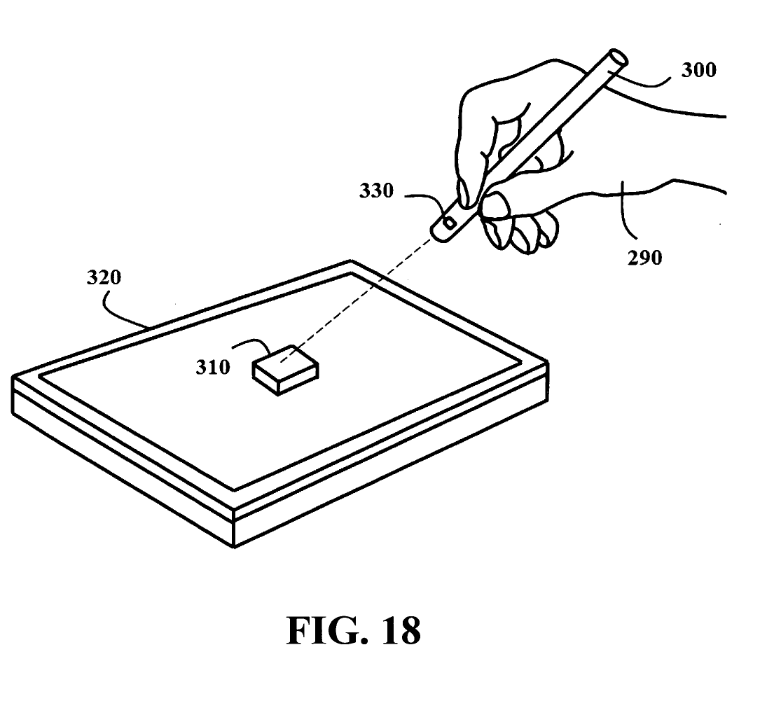

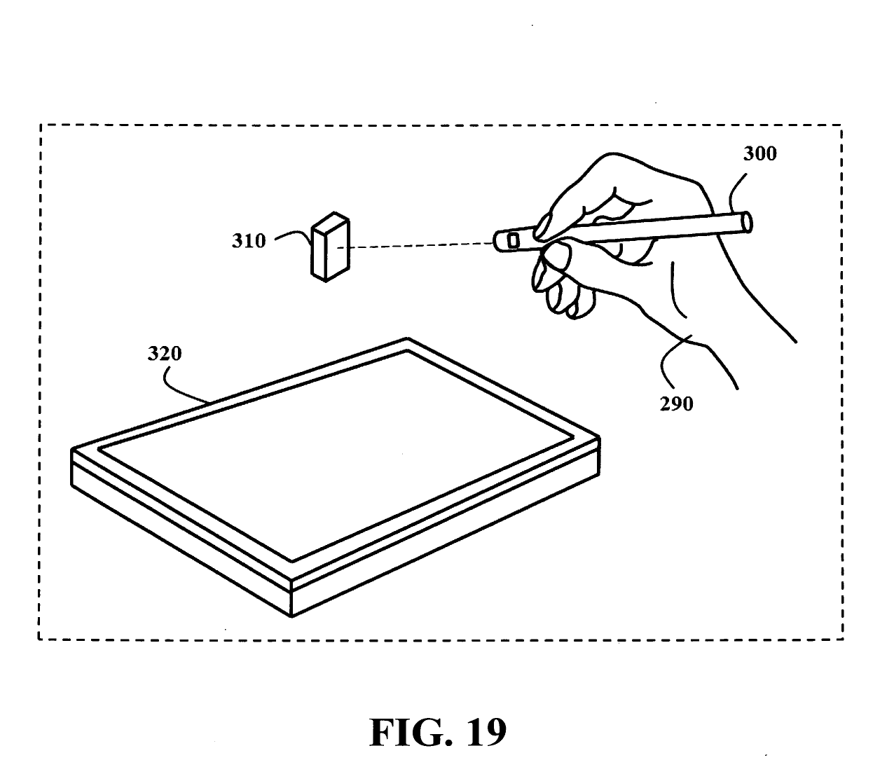

FIG. 18 illustrates a user's hand 290 holding a computer input device 300 in the form of a stylus to remotely select a 3D object 310 presented on a tablet display 320. The button 330 on the computer input device can be pressed to provide the computer system with an immediate input representing selecting, dragging, or dropping a virtual object. FIG. 19 illustrates relocating the 3D object in a position other than its original position by tilting the computer input device in a new direction. In this case, if the 3D object needs to be virtually located behind the tablet, the tablet camera captures the picture of the scene behind the tablet to present the new location of the 3D object with the captured scene as an augmented reality application. If the 3D object needs to be virtually located in a position other than behind the tablet, the new location of the 3D object will not be viewed until the user holds and moves the tablet to point the camera towards the new location of the 3D object. Of course, it possible to use an OHMD to view the 3D object at its new location without needing to move the tablet or to use its camera.

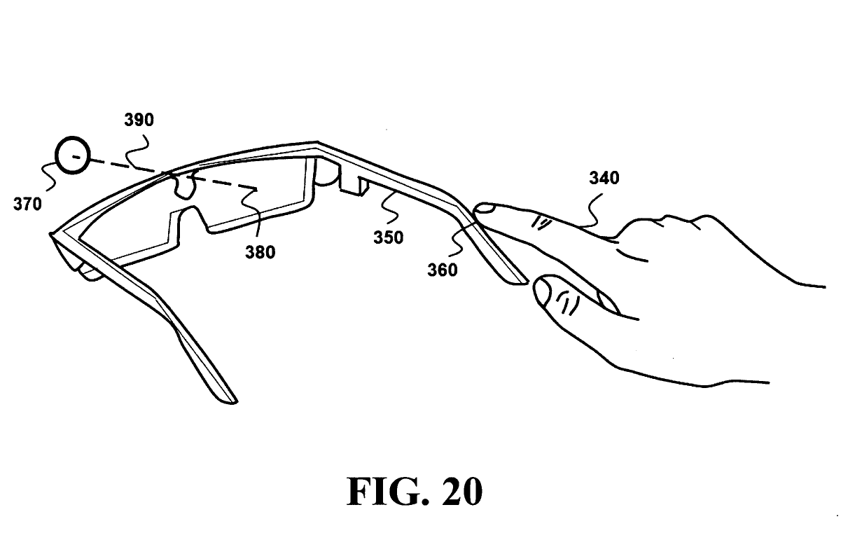

FIG. 20 illustrates another utilization of the present invention with an OHMD without using a camera. As shown in the figure, a finger 340 is touching an OHMD, in the form of eye glasses 340, at a certain position 250 that has a touch sensor that senses the 3D direction of the finger. The virtual object 370 is moved from its original position 380 to be located at a new position according to the new 3D direction indicated by the user's finger. The dotted line 390 represents the 3D direction of the finger, which represents the movement direction of the virtual object. There is no need to use a camera to track the finger movement when the touch sensor detects the 3D direction of the finger. The magnitude of the finger force or pressure detected by the touch sensor can represent the distance of moving the 3D object along the 3D direction of the finger.

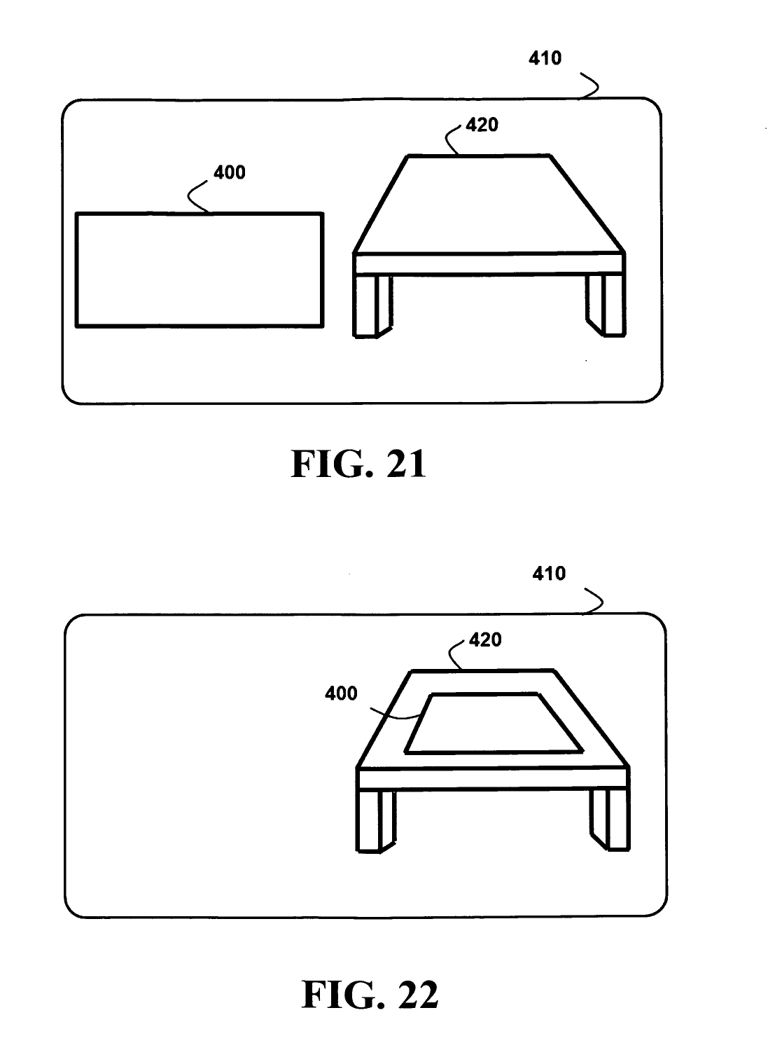

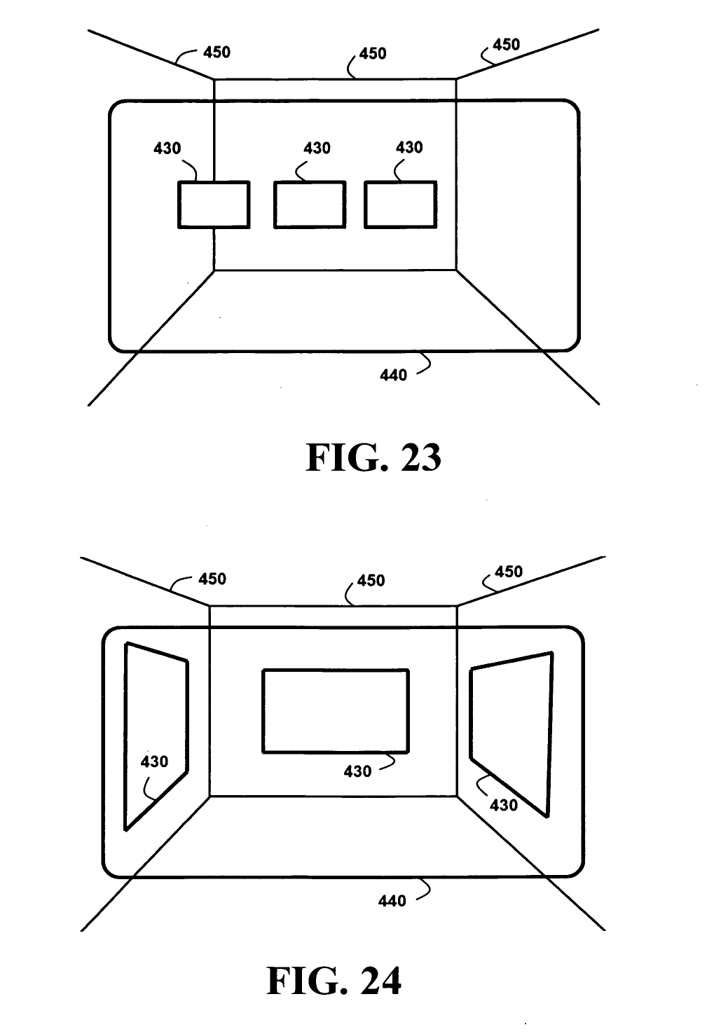

The concept of using the present invention in augmented reality applications can provide freedom to attach virtual windows to real objects that appear in the physical landscape of the user. For example, FIG. 21 illustrates a virtual window 400 presented on an OHMD 410 where a real table 420, located in front of the user, appears on the OHMD. FIG. 22 illustrates moving the virtual objects to be positioned on the table. FIG. 23 illustrates three windows 430 presented on an OHMD 440 where three real walls 450 located in front of the OHMD appear behind the three windows. FIG. 24 illustrates relocating the three windows to be virtually positioned on the three walls. Generally, to achieve this, the three windows are selected, moved, rotated, and resized to appear as shown in the figure, using the method of the present invention.

It is important to note that positioning the virtual windows on real objects, such as walls or furniture, means the virtual windows remain attached to these real objects regardless of the user's movement with the OHMD. Accordingly, when a user positions a plurality of virtual windows on the walls of different rooms of a building, s/he can walk through the physical landscape of the building and view the virtual windows attached in each room. The building essentially becomes 3D gallery with digital data, and the digital data can contain text, pictures, or videos as mentioned previously. In one embodiment of the present invention, each window virtually positioned on a real object can be associated with online content described by a URL. For example, a virtual window can be associated with a URL such as “www.cnn.com” which leads to the CNN news website. Accordingly, the content of this virtual window will change each time the CNN website itself undergoes a change in content. Of course, the virtual window can present a specific webpage of a website, or the homepage of the website, and the user can interact or browse the website at will, as will be described subsequently.

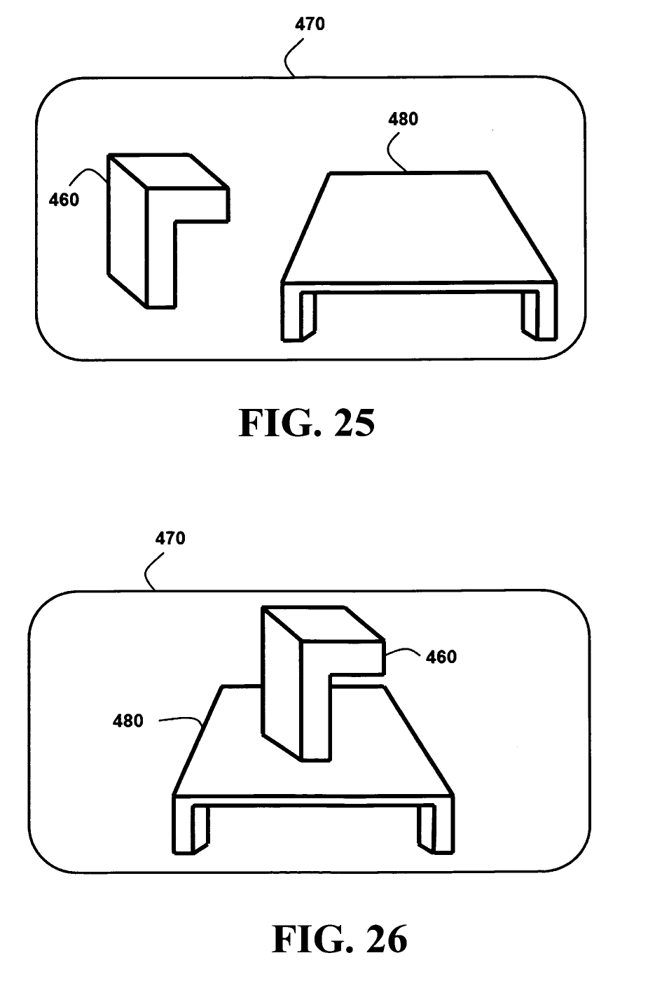

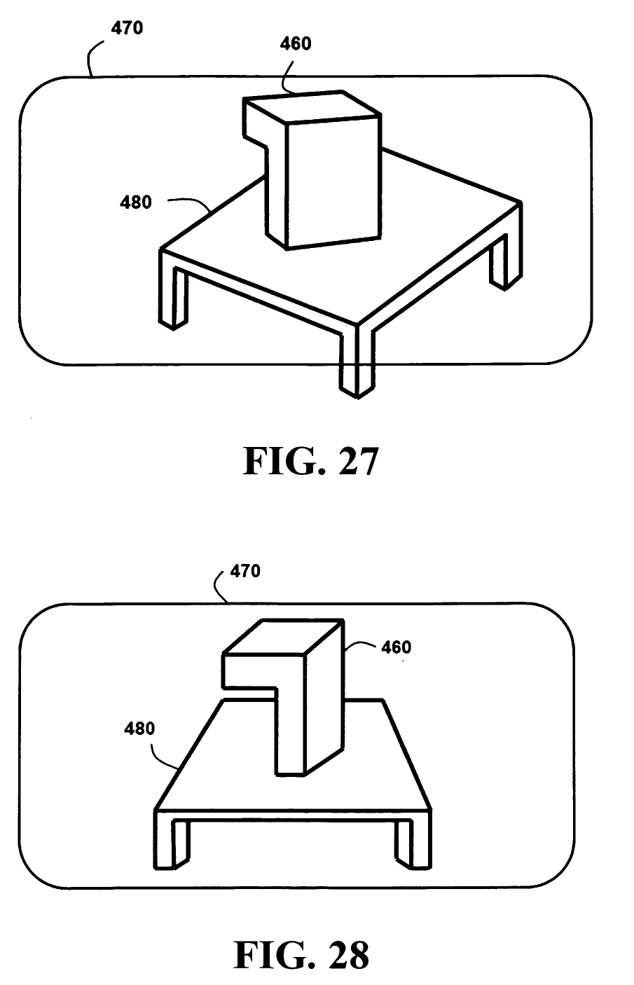

The previous examples demonstrate using the present invention when interacting with two-dimensional computer applications. However, the present invention is also helpful when interacting with three-dimensional computer applications. For example, FIG. 25 illustrates a 3D object 460 presented on a OHMD 470, with a real table located in front of the OHMD, as it can be seen beside the 3D object. FIG. 26 illustrates virtually relocating the 3D object so it is positioned on the real table using the present invention. FIGS. 27 and 28 illustrate different views of the 3D object when the user moves around the real table. As shown in these two figures, the views of the 3D object change with the change of the user's position where the 3D object has a fixed position on top of the real table. This example presents the uniqueness of using the present invention in visualizing the 3D objects in various augmented reality applications.

Overall, the main advantages of the present invention is utilizing an existing hardware technology that is simple and straightforward which easily and inexpensively carries out the interaction method of the present invention. For example, in FIG. 2 the selection of the virtual window is achieved by tracking the position of a finger relative to the user's eyes. The tracking is done by a digital camera attached to the OHMD. Once the finger points towards a virtual window and taps in the air, it is interpreted as a signal for selecting the virtual window that the finger is pointing to. The finger's movement in the air is also tracked by a digital camera to determine the new position of the virtual window in the air. Once the finger stops moving and taps again, this second tapping is interpreted as a signal for dropping the virtual window at the finger's position in mid-air.

To rotate the virtual window vertically or horizontally, move the virtual window away or closer to the user, or resize the virtual window in its position in the air, the user provides an immediate input representing a rotation, movement, or resizing. The user input can be done with many gestures, each of which can represent a rotation, moment, or resizing with certain criteria. For example, the rotation can be described by a vertical angle or horizontal angle. The movement can be described by a 3D direction and a distance along this 3D direction, similar to using the spherical coordinate system. The 3D direction can be described by a first angle located between a line representing the 3D direction and the xy-plane, and a second angle located between the projection of the line on the xy-plane and the x-axis. The resizing can be described by a positive or negative percentage of the original size of the virtual window.

In addition to the gestures, the present invention can utilize natural language voice commands to provide an immediate input to a computer system representing the intended rotation, movement, or resizing. For example, a command such as “rotation, vertical, 90” can be interpreted to represent “a vertical rotation with an angle equal to 90 degrees”. Also, a command such as “movement, 270, 45, 100” can be interpreted to represent a movement in a 3D direction with a vertical angle equal to 270 and a horizontal angle equal to 45, as well as a distance along this 3D direction equal to 100 units. A command such as “resize, 50” can be interpreted as resizing the virtual window 50% compared to its original size.

In FIG. 14 the selection of the virtual window is done by touching the touchscreen of the mobile phone. The movement of the finger is tracked by the mobile phone camera. However, as mentioned previously, if the user is using an OHMD, there is no need to use the mobile phone camera when the camera present in the OHMD can track the user's finger movement in the air. It is also possible to relocate the virtual window in the air without using any cameras at all. This is achieved by titling the mobile phone to be orthogonal to the desired direction of the virtual window movement while touching a certain icon on the mobile phone touchscreen. The virtual window keeps moving along the desired direction as long as the user keeps touching the icon. Once the user releases the icon, the virtual window stops its movement along the desired direction, to be left suspended in its a final position.

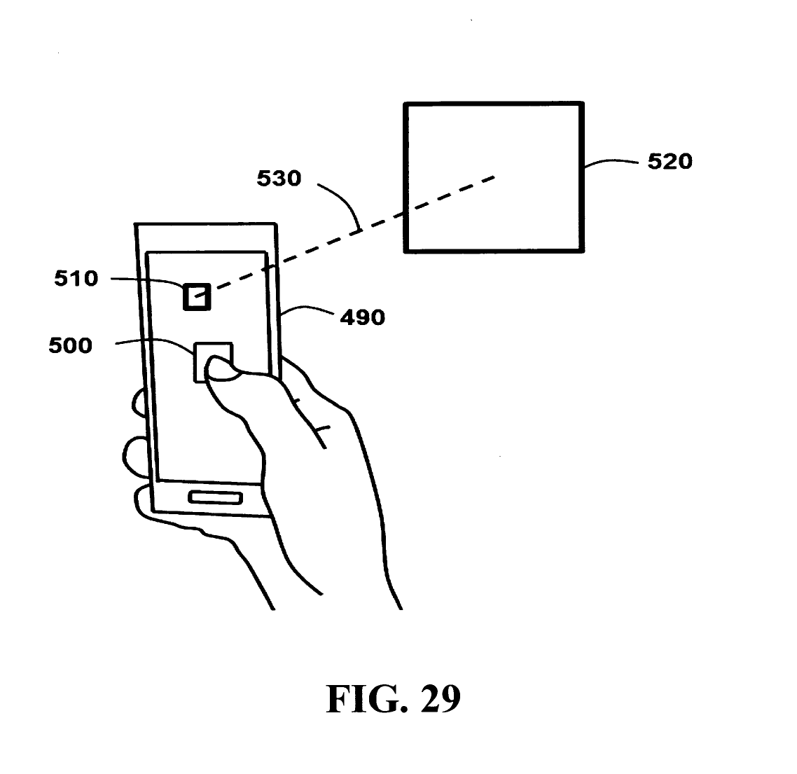

The tilted angle of the mobile phone indicates the orthogonal angle of the virtual window movement. The length of time the icon is pressed represents the movement of the virtual window along the orthogonal angle. The GPS of the mobile phone detects the position of the mobile phone, which represents the start position of the virtual window. The orthogonal angle and distance of the virtual window movement, relative to the start position of the mobile phone, determines the final position of the virtual window after its movement. FIG. 29 illustrates a user's hand holding a mobile phone 490, while a finger is touching an icon 500 on the mobile phone screen, to move a virtual window 510 from its start position on the mobile phone screen to a final position 520 in the air. The dotted line 530 represents an orthogonal direction to the plane of the mobile phone screen, and also represents the movement direction of the virtual window in the air. The length of the dotted line depends on the time period the icon is pressed, as was described previously. The same method used with the mobile phone can be used with other devices such as a tablet screen, OHMD, or HMD. In such cases, the tilting of the device determines the orthogonal direction of the virtual window movement.

In FIG. 16, the detection of the finger movement is achieved through a camera attached to the computer screen. The camera can be a depth sensing camera that tracks the distance of the finger relative to the camera or the computer screen. Moving the finger closer to the computer screen, after selecting a virtual window moves the virtual window away from the user. Moving the finger away from the computer screen after selecting a virtual window moves the virtual window closer to the user. In FIG. 18, the computer input device can be equipped with a front facing camera, where a marker is positioned at each corner of the tablet. The movement of the computer input device relative to the tablet can be determined by tracking the positions of the markers relative to the camera position, as known in the art.

In the case of positioning a plurality of virtual windows inside different rooms of a building, a database stores the 3D model of the rooms and buildings to show or hide the virtual windows on the device display according to which room the user is standing in. Of course, the user may prefer to view all virtual windows located inside the entire building from each room. In this case, the walls of the room will not block any virtual windows, which means the 3D model of the rooms and building will be ignored.

In FIG. 20, the frame of the eye glasses is equipped with a force sensor similar to the 3D force sensor disclosed in the U.S. patent application Ser. No. 14/157,499. In this case, the 3D force sensor senses the 3D direction of the finger touch, and the magnitude of the force applied by the finger to the frame of the eye glasses. The 3D direction of the finger represents the movement direction of the virtual window, and the magnitude of the force represents the distance of the virtual window movement along the 3D direction. In FIGS. 21 to 28, the detection of the position and shape of the real object is also achieved by using a depth sensing camera attached to the OHMD. Once the user moves a virtual window to position it on a real object, the computer system projects or presents the virtual window on the OHMD to appear as it is located on the real object.

In another embodiment, the present invention allows a group of users to interact with virtual data located suspended in the atmosphere around them. Each one of the users can select virtual data on a device display and drag the virtual data to a desired position in mid-air. All users can view the virtual data at its new location by aiming a device display towards this location. This innovative application enhances the collaborative interaction of a group of users with virtual data, opening the door for various gaming, entertainment, educational, and professional applications. Additionally, the group of users can be located in different locations or cities, and still maintain an interaction with the same virtual data. In this case, each virtual window suspended in the air will be presented around each user at his/her location. Once a user changes the position and/or content of a virtual window, these changes appears to all users at their locations.

Generally, when using a device such as a HMD, OHMD, tablet, or mobile phone, the device is equipped with a camera, processor, 3D compass, GPS, accelerometer, and movement sensing unit. The camera captures the picture of the user's finger. The processor analyzes the picture of the finger to determine its position relative to the user's eye. The position of the finger is compared with the virtual windows presented on the display to determine which virtual window the user is selecting. The processor reshapes the selected virtual window to match the finger's movement when moving, rotating, or resizing the virtual window. Once the virtual window is moved to a new location in mid-air, and the device display is not facing this new location, the virtual window remains at its position and disappears on the device display. If the device display is moved again to face the location of the virtual window then the virtual windows appears on the device display as it is suspended in the air. The 3D compass detects the tilting of the device in three dimensions, and the GPS determines the current position or coordinates of the device location. The accelerometer and movement sensing unit determine the movement of the device relative to its original position.

In another embodiment of the present invention, a modern retinal projector is utilized to project the image of the virtual window onto the user's retina. In this case, the image of the virtual window changes to correspond to the location of the virtual window in the air. Since the user sees the scene in front of him/her, accordingly, the virtual window will look like it is suspended in the air in front of the scene.

In one embodiment, there is no need to select a virtual window from a device display: the user can directly create a virtual window in the air in front of him/her. This is achieved by selecting a position for the virtual window in mid-air by a finger, drawing the boundary lines of the virtual window, and describing the content of the virtual window. The content of the virtual window can be described by a URL, as was described previously. Also, the content of the virtual window can be described by a name of a desktop application such as MICROSOFT WORD to display this application in and-air in front of the user, who is free to interact with it. Of course, in all such cases, the user needs to use a device display such as a HMD, OHMD, tablet, or mobile phone, or to use a retinal projector to view the virtual window. However, to describe the content of the virtual window the user may use natural language voice commands to describe this content. Also, the user may write in the air, and this freehand writing is tracked by a camera which interprets this as digital text describing the content of the virtual window.

Finally, it is important to note that the present invention can virtually move a virtual window from a first position on a device display to a second position in mid-air. Also, the present invention can virtually move the virtual window from the second position in mid-air to its first or original position on the device display. Moreover, the present invention can move a virtual window from a first position on a first device display to a second position on a second device display. In this case, the present invention will project the picture of the virtual window on the second device display, where the user can see this projected picture when using an OHMD or aiming the first device display towards the second device display.

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art, which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A method to relocate a virtual window from a first position on a display to a second position in the air wherein the method comprising;
providing a first input representing the selection of the virtual window at the first position;
providing a second input representing the location of the second position relative to the first position, and
relocating the virtual window to appear at the second position through the display.

2. The method of claim 1 wherein the content of the virtual window is associated with online content described by a URL.

3. The method of claim 1 wherein the first input is gestures or natural language voice commands, and the second input is hand movements or device movements.

4. The method of claim 1 wherein the display is an optical head-mounted display, head-mounted display, tablet screen, mobile phone screen, or retinal projector.

5. The method of claim 1 further the virtual window can be moved, rotated, or resized in the air.

6. The method of claim 1 further the virtual window can be accessible to a group of users wherein each one of the group of users is at a different location.

7. The method of claim 1 wherein the display is an optical head-mounted display, head-mounted display, tablet screen, mobile phone screen, or retinal projector.

8. The method of claim 1 wherein the location of the second position is determined to remain the virtual window stationed at the second position regardless of the movement of the display or the user.

9. The method of claim 1 wherein the virtual window is a three-dimensional virtual object.

10. The method of claim 1 wherein the second position is a located on a real object such as a wall or piece of furniture.

11. The method of claim 10 wherein the second input is represented by pointing to the real object by a gesture.

12. The method of claim 10 further a depth sensing camera is utilized to detect the locations of the real object points relative to the position of the display.

13. A method to move a virtual window from a first position on a display to a second position in the air wherein the method comprising;
providing a first input representing the selection of the virtual window at the first position;
tilting the display to be orthogonal to the direction of the virtual window movement;
providing a second input representing the time period of the virtual window movement along the direction; and
moving the virtual window along the direction to stop at the second position at the end of the time period.

14. The method of claim 13 wherein the display is a mobile phone screen, tablet screen, optical head-mounted display, or head-mounted display.

15. The method of claim 13 wherein the second input is provided by pressing an icon presented on the display.

16. The method of claim 13 wherein the location of the second position is determined to remain the virtual window stationed at the second position regardless the movement of the display.

17. A method for creating a virtual window to be stationed at a location in the air wherein the method comprising;
providing a first input representing the location of the virtual window;
providing a second input representing the boundary lines of the virtual window;
providing a third input representing the content of the virtual window; and
presenting the content inside the boundary lines at the location to be seen through a display.

18. The method of claim 17 wherein the first input and the second input are represented by hand gestures.

19. The method of claim 17 wherein the third input is represented by writing in the air or providing natural language voice commands.

20. The method of claim 17 wherein the content of the virtual window is associated with online content described by a URL.
